(19) United States
(12) Patent Application Publication
(10) Pub. No.: US 2026/0080141 A1
(43) Pub. Date: Mar. 19, 2026

(54) INTEGRATED CIRCUIT INCLUDING STANDARD CELL AND LAYOUT DESIGN METHOD THEREOF

(71) Applicant: Samsung Electronics Co., Ltd., Suwon-si (KR)

(72) Inventor: Seung Man LIM, Suwon-si (KR)

(73) Assignee: Samsung Electronics Co., Ltd., Suwon-si (KR)

(21) Appl. No.: 19/219,383

(22) Filed: May 27, 2025

(30) Foreign Application Priority Data
Sep. 13, 2024 (KR) 10-2024-0126135

(51) Int. Cl. G06F 30/392; G06F 30/20; G06F 30/3953; G06F 30/398; G06F 113/18; G06F 119/18; H10D 84/83

(52) U.S. Cl. CPC G06F 30/392; G06F 30/20; G06F 30/3953; G06F 30/398; H10D 84/83; G06F 2113/18; G06F 2119/18

(57) ABSTRACT

Example embodiments provide a layout design method for an integrated circuit including obtaining a connection relationship of multiple standard cells, placing a first standard cell of the plurality of standard cells and a second standard cell of the plurality of standard cells adjacent to each other in a first direction based on the connection relationship between the first standard cell and the second standard cell, and placing a cutting layer for a contact layer between the first standard cell and a third standard cell of the plurality of standard cells arranged adjacent to the first standard cell in the first direction based on the connection relationship between the first standard cell and the second standard cell.

### CROSS-REFERENCE TO RELATED APPLICATION

This U.S. non-provisional application claims priority under 35 U.S.C. § 119 to Korean Patent Application No. 10-2024-0126135, filed in the Korean Intellectual Property Office on Sep. 13, 2024, the entire contents of which are incorporated herein by reference.

### BACKGROUND

Example embodiments relate to an integrated circuit including a standard cell and a layout design method thereof.

Integrated circuits that process digital signals may be designed based on standard cells. A functional circuit may be formed by arranging and routing standard cells such that the integrated circuit implements a desired function.

As demands for higher performance, higher speed, and/or multi-functionality of integrated circuits increase, integration density of the integrated circuits may increase. As integration of the integrated circuits increases, layout structures of standard cells that reduce or minimize routing congestion and/or increase or optimize area of the integrated circuits are being studied.

### SUMMARY

Example embodiments of the present disclosure are directed to an integrated circuit including a standard cell and a layout design method thereof that may reduce or minimize routing congestion and reduce and/or optimize an area of the integrated circuit.

Example embodiments of the present disclosure are directed to an integrated circuit including a standard cell and a layout design method thereof that may minimize or reduce a turn around time (TAT).

According to some example embodiments, a layout design method for an integrated circuit includes obtaining a connection relationship of a plurality of standard cells, placing a first standard cell of the plurality of standard cells and a second standard cell of the plurality of standard cells adjacent to each other in a first direction based on the connection relationship between the first standard cell and the second standard cell, and placing a cutting layer for a contact layer between the first standard cell and a third standard cell of the plurality of standard cells based on the connection relationship between the first standard cell and the third standard cell. The third standard cell is arranged adjacent to the first standard cell in the first direction.

According to some example embodiments, an integrated circuit includes a first line configured to extend in a first direction, and a first standard cell configured to have a size defined by a plurality of first cell boundaries extending in the first direction and positioned along a second direction perpendicular to the first direction and a plurality of second cell boundaries extending in the second direction and positioned along the first direction. The first standard cell includes a first active region and a first contact layer extending in the second direction and contacting the first active region, and wherein at least one of the first cell boundaries overlaps the first line. The integrated circuit further includes a second standard cell configured to have a size defined by a plurality of third cell boundaries extending in the first direction and positioned along the second direction and a plurality of fourth cell boundaries extending in the second direction and positioned along the first direction. The second standard cell includes a second active region and a second contact layer extending in the second direction and directly connected to the first contact layer and contacting the second active region, and wherein at least one of the third cell boundaries overlaps the first line.

According to some example embodiments, a semiconductor device includes a substrate configured to include a first cell region and a second cell region adjacent to the first cell region in a first direction; a first source region and a first drain region on the substrate and spaced apart in the first direction from each other within the first cell region, a second source region and a second drain region on the substrate and spaced apart in the first direction from each other within the second cell region, and a first contact layer extending in the first direction and on the first source region, the first drain region, the second source region, and the second drain region, and contacting the first source region, the first drain region, the second source region, and the second drain region.

### BRIEF DESCRIPTION OF THE DRAWINGS

FIG. 1 illustrates a flowchart for describing a method of designing and manufacturing an integrated circuit, according to some example embodiments.

FIG. 2 illustrates a cross-sectional view of a region of an integrated circuit, according to some example embodiments.

FIG. 3 illustrates a layout view of a standard cell, according to some example embodiments.

FIG. 4 illustrates a circuit diagram of the standard cell of FIG. 3.

FIG. 5 illustrates a layout view of standard cells, according to some example embodiments.

FIG. 6 illustrates a circuit diagram of the standard cells of FIG. 5.

FIG. 7 illustrates a cross-sectional view in a line A-A′ of FIG. 5.

FIG. 8 illustrates a layout view of standard cells, according to some example embodiments.

FIG. 9 illustrates a flowchart showing a standard cell positioning method of an integrated circuit design tool, according to some example embodiments.

FIG. 10 illustrates a layout view of a standard cell stored in a cell library according to a comparative example.

FIG. 11 illustrates a layout view for describing a standard cell layout method of an integrated circuit design tool according to a comparative example.

FIG. 12 illustrates a circuit diagram for describing a connection method of a standard cell, according to some example embodiments.

FIG. 13 illustrates a circuit layout of the circuit of FIG. 12 including a standard cell, according to some example embodiments.

FIG. 14 illustrates a circuit diagram for describing a connection method of a standard cell according to some example embodiments.

FIG. 15A illustrates a layout of a circuit according to FIG. 14 including a standard cell, according to some example embodiments.

FIG. 15B illustrates a cross-sectional view of a line B-B′ of FIG. 15A.

FIG. 16 illustrates a schematic diagram showing a design system for designing an integrated circuit, according to some example embodiments.

### DETAILED DESCRIPTION

Hereinafter, example embodiments will be described in more detail with reference to accompanying drawings. The same reference numerals are used for the same components in the drawings, and duplicate descriptions thereof are omitted for the sake of brevity of explanation.

It should be understood that the example embodiments described herein are intended to implement various features of the present disclosure. The example embodiments are merely examples and are not intended to be limiting. For example, the dimensions of the components are not limited to the published ranges or values and may vary depending on process conditions and/or desired device properties. In addition, in the following description, the formation of the first structure on or above the second structure may include example embodiments in which the first and second structures are formed in direct contact, and example embodiments may also include where additional structures may be formed between the first and second structures such that the first and second structures are not in direct contact. For simplicity and clarity, various structures may be drawn arbitrarily at different scales.

In addition, spatially related terms, such as “below”, “lower”, “lower portion”, “above”, “upper portion”, etc., may be used for ease of description to depict the relationship of any one element or structure illustrated in the drawing to another element or structure.

Accordingly, the drawings and description are to be regarded as illustrative in nature and not restrictive. Like reference numerals designate like elements throughout the specification. In a flowchart described with reference to the drawings, an order of operations may be changed, several operations may be merged, some operations may be divided, two or more operations may be performed simultaneously, and one or more operations may not be performed.

In addition, expressions written in the singular may be construed in the singular or plural unless an explicit expression such as “one” or “single” is used. Terms including ordinal numbers such as first, second, and the like will be used only to describe various component and are not to be interpreted as limiting these components. These terms may be used for the purpose of distinguishing one constituent element from other constituent elements.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,”respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a. tolerance of ±10%).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element, value, and/or property is referred to as being the same as another element, value, and/or property, it should be understood that an element, value, and/or property is the same as another element, value, and/or property within a desired manufacturing or operational tolerance range (e.g., ±10%).

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

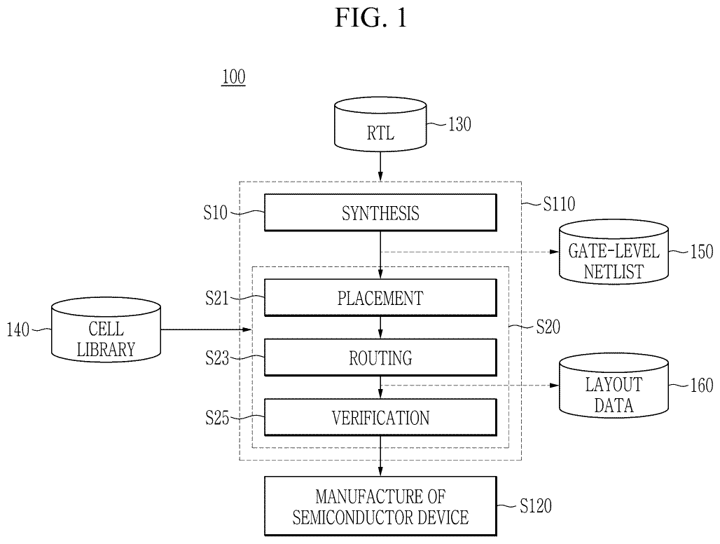

FIG. 1 illustrates a flowchart for describing a method of designing and manufacturing an integrated circuit according to some example embodiments.

Referring to FIG. 1, the design and manufacturing method 100 for an integrated circuit may include a design operation (S110) of an integrated circuit and a manufacturing operation (S120) of an integrated circuit. The design operation (S110) of an integrated circuit, which is an operation of generating a gate level netlist (150), designing layout data (160) for a circuit, and verifying it, may be performed in a design tool for an integrated circuit for designing and verifying an integrated circuit.

The design operation (S110) of an integrated circuit may include a logic synthesis operation (S10) and a physical design operation (S20). The logic synthesis operation (S10) may refer to an operation of generating a gate level netlist 150 from RTL data 130. For example, an integrated circuit design tool (e.g., a logic synthesis tool) may perform logic synthesis to generate the gate level netlist 150 (hereinafter, referred to as a “netlist”) from RTL data 130 written in a hardware description language (HDL) such as a VHSIC hardware description language (VHDL) and Verilog. The netlist 150 may refer to a logical schematic that expresses a connection relationship between cells within an integrated circuit.

The physical design operation (S20) may include a placement operation (S21), a routing operation (S23), and/or a verification operation (S25). The integrated circuit design tool may receive a cell library 140, and perform one or more operations based on the cell library 140.

In the placement operation (S21), standard cells may be placed. For example, an integrated circuit design tool (e.g., a place and route (P&R) tool) may place standard cells used in the netlist 150. The integrated circuit design tool may place standard cells based on information related to the standard cells stored in the cell library 140. The cell library 140 may include layout information such as height and size information for standard cells and characteristic information such as delay and leakage current for standard cells. Herein, the standard cells may include logic elements such as AND, OR, inverters, and memory elements such as flip-flops. A standard cell may be implemented by at least one transistor, a metal oxide semiconductor field effect transistor (MOSFET), a FinFET, etc., but example embodiments are not limited thereto.

In some example embodiments, the cell library 140 may include layout information of the standard cells. A standard cell may have a structure in which multiple layers are stacked, and may be configured in a pattern formed in the multiple layers. The cell library 140 may include geometric information of multiple layers forming a standard cell.

The multiple layers may include conductive layers, such as a contact layer and a metal layer, and a cutting layer. The cutting layer may be a layer for electrically insulating the standard cells. For example, conductive layers between adjacent standard cells may be physically or electrically separated (or insulated) by a cutting layer. The contact layer may be a source/drain contact. The contact layer may include a power contact layer connected to a supply voltage (e.g., VDD) or a ground voltage (e.g., VSS), and an interface contact layer connected to another standard cell, etc., to transmit and receive signals. Furthermore, the contact layer may further include an internal contact layer that connects transistors inside the standard cell. The interface contact layer may correspond to an input pin or an output pin of a standard cell. Hereinafter, source/drain nodes of the transistors corresponding to the interface contact layer may be referred to as interface nodes.

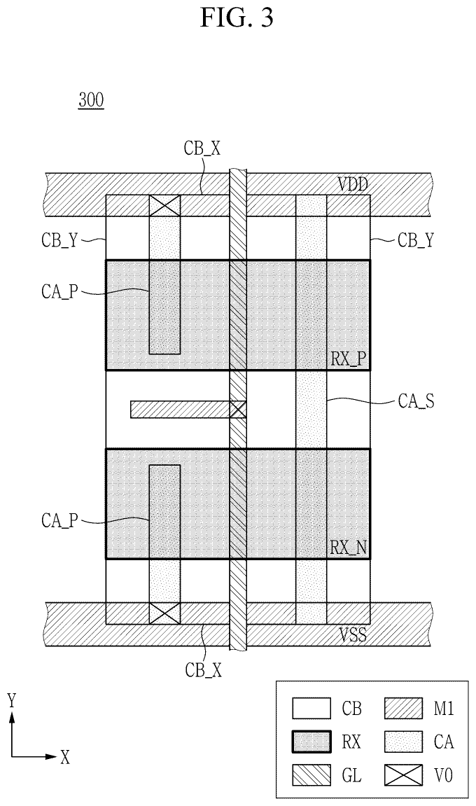

In the placement operation (S21), the integrated circuit design tool may place standard cells by considering the connection relationship between the standard cells. Specifically, the integrated circuit design tool may place standard cells by considering the connection relationship between the standard cells based on the netlist 150, and certain standard cells among the standard cells may be placed adjacently in a second direction perpendicular to a first direction (e.g., the direction X of FIG. 3). For example, among the standard cells, standard cells that are interconnected may be placed adjacent to each other in a second direction (e.g., the direction Y in FIG. 3) that intersects the first direction. Alternatively or additionally, standard cells having output pins interconnected among the standard cells may be placed adjacent to each other in the second direction perpendicular to the first direction.

In some example embodiments, the cell library 140 may not include a cutting layer for at least one contact layer forming a standard cell. For example, the cell library 140 may not include a cutting layer for an interface contact layer among the contact layers forming a standard cell. Accordingly, interface contact layers of standard cells placed adjacent each other in the second direction may be directly connected in the second direction. In some example embodiments, the integrated circuit design tool may omit the routing operation (S23) for the standard cells to which the interface contact layer is connected, considering a connection relationship of the standard cells. Accordingly, routing congestion of integrated circuits may be reduced or minimized and a turn around time (TAT) may be improved or optimized.

In some example embodiments, the integrated circuit design tool may place a cutting layer for the contact layer to electrically insulate the interface contact layers of the standard cells. For example, the integrated circuit design tool may place the standard cells by considering the connection relationship between the standard cells, and may place a cutting layer for the interface contact layers to electrically insulate the interface contact layers of some of the standard cells among the adjacently placed standard cells. For example, the integrated circuit design tool may place non-interconnected standard cells (e.g., standard cells that do not directly transmit or receive signals) adjacent to each other in the second direction due to a limited area of the integrated circuit. Accordingly, in order to electrically insulate non-interconnected standard cells among the standard cells arranged adjacently in the second direction, a cutting layer may be placed for the interface contact layer. The interface contact layer and the cutting layer for the interface contact layer may be positioned in a same layer.

In some example embodiments, the cell library 140 may include a cutting layer for some contact layers among the contact layers forming a standard cell. Herein, some contact layers may be internal contact layers connecting the transistors inside the standard cell. A description of standard cells SC according to some example embodiments will be provided below with reference to FIGS. 3 to 12.

In the routing operation (S23), pins of standard cells may be routed. For example, the integrated circuit design tool may generate multiple layers and vias that electrically connect output pins and input pins of placed standard cells, and may generate layout data 160 that may define the placed standard cells and the multiple layers and vias that are generated. The layout data 160 may have a format such as GDSII, for example, and may include geometric information of cells and multiple layers and vias, for manufacturing photomasks that are used to manufacture the integrated circuit.

The verification operation (S25) may be an operation for verifying and modifying a generated layout. Verification items may include a static timing analysis (STA), which may verify that the layout satisfies a timing condition of the design; a design rule check (DTC), which may verify that the layout is made according to the design rule; an electronic rule check (ERC), which may verify that the layout is made with minimal internal electrical disconnections, and a layout versus schematic (LVS), which may verify that the layout matches the netlist.

The manufacturing operation (S120) of the integrated circuit may include multiple operations for manufacturing a mask (e.g., by using the layout data) and forming a semiconductor package.

The manufacturing operation (S120) of the integrated circuit may include an operation of performing optical proximity correction (OPC), etc. on the layout data 160 generated in the design operation (S110) of the integrated circuit to generate mask data for forming various patterns in multiple layers, and an operation of manufacturing a mask using the mask data. In the manufacturing operation (S120) of the integrated circuit, various types of exposure and etching processes may be performed repeatedly. Through these processes, shapes of patterns configured during layout design may be sequentially formed on a semiconductor (e.g., silicon) substrate.

Furthermore, in the manufacturing operation (S120) of the integrated circuit, a packaging process may be performed to mount a semiconductor device produced by the integrated circuit on a PCB and mold or encapsulate it with a molding material. Through the packaging process, semiconductor devices may be flipped or bonded onto a substrate using multiple contact members.

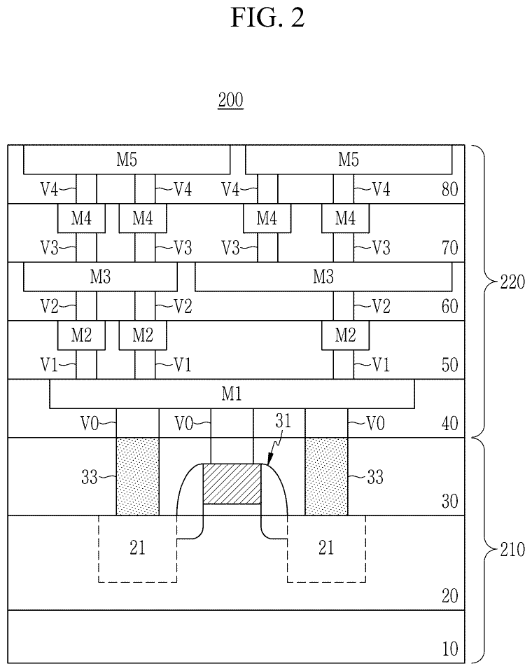

FIG. 2 illustrates a cross-sectional view of a region of an integrated circuit according to some example embodiments. However, example embodiments are not limited thereto, and additional circuit configurations may be included between each layer or in each layer. The detailed descriptions of the constituent materials of each component and a formation method of each component will be omitted herein for the sake of brevity.

In some example embodiments, the integrated circuit 200 may include a front-end-of-line (FEOL) region 210 and a back-end-of-line (BEOL) region 220. The FEOL region 210 may correspond to standard cells stored in the cell library 140 (in FIG. 1), and the standard cells may be placed by an integrated circuit design tool in the placement operation (S21 of FIG. 1). The BEOL region 220 may be created in the routing operation (S23 of FIG. 1).

Referring to FIG. 2, the FEOL region 210 may include a substrate 10. The substrate 10 may be a P-type substrate. Alternatively, the substrate 10 may be an N-type substrate.

The FEOL region 210 may include an active region 20 positioned or arranged on the substrate 10 and a source/drain region 21 formed in the active region 20. The FEOL region 210 may further include a gate structure 31 positioned or arranged between source/drain regions 21. The source/drain region 21 and the gate structure 31 may form a transistor.

The FEOL region 210 may include an insulating layer 30 disposed on the active region 20 and a contact layer 33 disposed on the insulating layer 30. The contact layer 33 may electrically contact the source/drain region 21. The contact layer 33 may connect the source/drain region 21 to a via V0. The source/drain region 21 may be connected to vias V0, V1, V2, V3, and V4 and routing layers M1, M2, M3, M4, and M5 within the BEOL region 220 through the contact layer 33. The integrated circuit 200 may further include the via V0 connected to the gate structure 31. A cutting layer for each conductive layer may be positioned in a same layer as a corresponding conductive layer. For example, a cutting layer for a contact layer may cut the contact layer in the same layer as the contact layer (e.g., an insulating layer 30).

The BEOL region 220 may be positioned on the FEOL region 210. The BEOL region 220 may electrically connect standard cells within the integrated circuit 200, and may enable the integrated circuit 200 to operate. The integrated circuit 200 may include a plurality of insulating layers 40, 50, 60, 70, and 80, vias V0, V1, V2, V3, and V4 formed in each of the insulating layers 40, 50, 60, 70, and 80, and routing layers M1, M2, M3, M4, and M5. Each of the vias V0, V1, V2, V3, and V4 may interconnect the routing layers M1, M2, M3, M4, and M5 positioned at different layers, and may connect the contact layer 33 to the routing layers M1, M2, M3, M4, and M5. Each of the routing layers M1, M2, M3, M4, and M5 may be referred to as a metal layer (or an upper metal layer) or as a conductive layer. The number of routing layers M1, M2, M3, M4, and M5 are not limited to 5 layers as illustrated. The integrated circuit 200 may include additional routing layers positioned or arranged on M5, as needed by application and/or design. Alternatively, the integrated circuit 200 may include less than 5 routing layers, as needed by application and/or design.

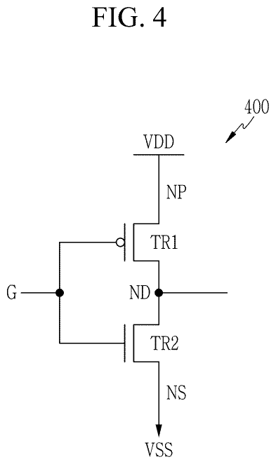

FIG. 3 illustrates a layout view of a standard cell 300, according to some example embodiments, and FIG. 4 illustrates a circuit diagram of the standard cell 300 of FIG. 3.

In some example embodiments, the integrated circuit design tool may design an integrated circuit using the standard cell 300 generated by the cell library 140 (FIG. 1). The standard cell 300 may include an active region RX, a gate line GL, and a contact layer CA, each of which is represented by a polygon, and the contact layer CA of the standard cell 300 may be connected to the first metal layer M1 through the via V0. Referring to FIG. 4 together with FIG. 3, the standard cell 300 of FIG. 3 correspond to a CMOS transistor 400 including a P-type transistor TR1 and an N-type transistor TR2.

Referring to FIG. 3, the standard cell 300 may be defined by a cell boundary CB, and the integrated circuit design tool may recognize the standard cell 300 using the cell boundary CB. The cell boundary CB may be configured to include a cell boundary CB_X in a first direction (e.g., a direction X) and a cell boundary CB_Y in a second direction (e.g., a direction Y) perpendicular to the first direction X. In some example embodiments, the size of the standard cell 300 can be determined by the cell boundary CB_X in the first direction X and the cell boundary CB_Y in the second direction Y perpendicular to the first direction X.

The standard cell 300 may include an active region RX. Two or more active regions RX (two shown) extending in the first direction X may be arranged along the second direction Y, and may be parallel to each other. An active pattern formed in the active region RX may intersect with a gate line GL to form a transistor. For example, an N-type transistor TR2 (FIG. 4) may be formed in an active region RX_P, and a P-type transistor TR1 (FIG. 4) may be formed in an active region RX_N formed in an N-well doped with an N-type impurity, but example embodiments are not limited thereto.

The standard cell 300 may include a gate line GL. The gate line GL may extend in the second direction Y, and may be formed of any material having electrical conductivity. Referring to FIG. 4 together with FIG. 3, the gate line GL may correspond to gate terminals G of the P-type transistor TR1 and the N-type transistor TR2. The gate line GL may correspond to an input pin of the standard cell 300. The gate line GL may be connected to the first metal layer M1 through the via V0. The gate line GL may receive externally provided signals (e.g., another standard cell) through a via V0 and the first metal layer M1. However, example embodiments are not limited thereto, and additional metal layers or vias may be connected between the gate line GL and the via V0.

The active pattern formed in the active region RX within the standard cell 300 may be formed in various shapes. For example, the standard cell 300 may be formed as a finFET including a fin-shaped channel region, or may be formed as a gate-all-around (GAA) transistor in which a gate line surrounds a channel, e.g., a nanowire, or may be formed as a multi-bridge channel (MBC) transistor in which a plurality of channel layers, e.g., a plurality of nanosheets, are stacked, and a gate line surrounds (or encloses) the nanosheets, but example embodiments are not limited thereto.

The standard cell 300 may include a contact layer CA. The contact layer CA may be placed on the active region RX and electrically connected to the active region RX. The contact layer CA may function as a source/drain contact, and may make electrical contact with a corresponding portion of the transistor, i.e., the source/drain region. The contact layer CA may extend in the second direction Y. The contact layer CA may include a power contact layer CA_P and an interface contact layer CA_S.

Referring to FIG. 4 together with FIG. 3, the interface contact layer CA_S may correspond to a node ND where a P-type transistor TR1 and an N-type transistor TR2 are connected. The interface contact layer CA_S may correspond to an output pin of the standard cell 300. In some example embodiments, the interface contact layer CA_S may extend in the second direction Y, and the interface contact layer CA_S may extend to the cell boundary CB_X.

The standard cell 300 according to some example embodiments may not include a cutting layer for the interface contact layer CA_S. Accordingly, the interface contact layer CA_S of the standard cell 300 may be directly connected in the second direction Y to the interface contact layer of another standard cell that is placed adjacent the second direction Y.

In some example embodiments, the power contact layer CA_P may function as a source/drain contact, and the transistor may be supplied with a power voltage VDD or a ground voltage VSS through the power contact layer CA_P. The power contact layer CA_P may be connected to the power lines VDD and VSS of the first metal layer M1 through the via V0. Referring to FIG. 4, one power contact layer CA_P may correspond to a first terminal NP of the P-type transistor TR1 connected to the power voltage VDD and a second power contact layer CA_P may correspond to a first terminal NS of the N-type transistor TR2 connected to the ground voltage VSS. Although the power contact layer CA_P is depicted herein as two separate layers spaced from each other in the second direction Y, example embodiments are not limited thereto. For example, in some example embodiments, the power contact layer CA_P may extend in the second direction Y to the cell boundary CB_X, and the standard cell 300 may include a cutting layer to physically and electrically isolate the power contact layer CA_P.

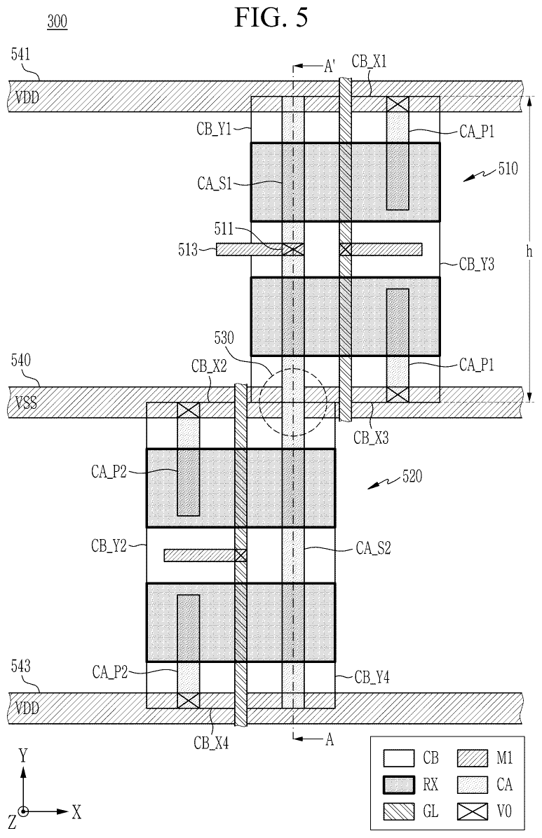

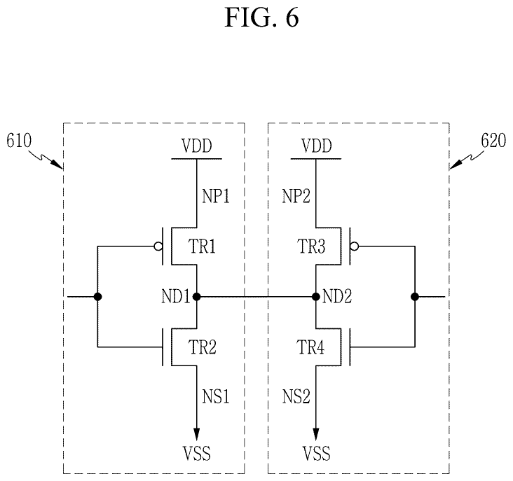

FIG. 5 illustrates a layout view of standard cells, according to some example embodiments, and FIG. 6 illustrates a circuit diagram of the standard cells of FIG. 5.

Referring to FIG. 5, standard cells 510 and 520 may be placed across first metal layers M1 between first metal layers M1 extending in the first direction X and placed parallel to each other in the second direction Y. For example, the first metal layers M1 may extend in the first direction X and the standard cells 510 and 520 may overlap some (e.g., one or more) areas of the first metal layers M1 in the third direction Z. The first metal layers M1 extending in the first direction X may supply the power voltage VDD and the ground voltage VSS to the standard cells 510 and 520. A height h of the standard cells 510 and 520 may be equal to a distance between the first metal layers M1 extending in the first direction X and adjacent in the second direction Y. However, in some example embodiments the standard cells 510 and 520 may have different heights.

Referring to FIG. 6 together with FIG. 5, the first standard cell 510 may correspond to the first transistor 610, and the second standard cell 520 may correspond to a second transistor 620. The integrated circuit design tool may place the first and second standard cells 510 and 520 adjacent to each other in the second direction Y, considering the connection relationship between the first transistor 610 and the second transistor 620. The integrated circuit design tool may determine that the first transistor 610 and second transistor 620 are interconnected. For example, an output node ND1 of the first transistor 610 and output node ND2 of the second transistor 620 may be directly connected, so the integrated circuit design tool may determine that the first and second standard cells 510 and 520 are interconnected, and may place the first and second standard cells 510 and 520 adjacent to each other in the second direction Y.

In some example embodiments, the standard cells being arranged adjacent to each other in the second direction Y may include the standard cells receiving the power voltage VDD or the ground voltage VSS from a same first metal layer extending in the first direction X, and interface contact layers of the standard cells being directly connected in the second direction Y. The first standard cell 510 and the second standard cell 520 may receive the power supply voltage VDD or the ground voltage VSS from the same first metal layer 540 extending in the first direction X. The first standard cell 510 and the second standard cell 520 may overlap a portion of the first metal layer 540 extending in the first direction X between the first standard cell 510 and the second standard cell 520. In some example embodiments, one cell boundary CB_X3 of the cell boundaries CB_X1 and CB_X3 of the first standard cell 510 in the first direction X and one cell boundary CB_X2 of the cell boundaries CB_X2 and CB_X4 of the second standard cell 520 may overlap the first metal layer 540. The first metal layer 541 overlapping the cell boundary CB_X1 among the cell boundaries CB_X1 and CB_X3 of the first standard cell 510 in of the first direction X and the first metal layer 543 overlapping the cell boundary CB_X4 among the cell boundaries CB_X2 and CB_X4 of the second standard cell 520 may be different from each other. Alternatively, positions (e.g., coordinates) of one cell boundary CB_X3 of the cell boundaries CB_X1 and CB_X3 of the first standard cell 510 in the first direction X and one cell boundary CB_X2 of the cell boundaries CB_X2 and CB_X4 of the second standard cell 520 in the second direction Y may be the same. In other words, the cell boundary CB_X3 and cell boundary CB_X2 may be considered collinear. The interface contact layer CA_S1 of the first standard cell 510 and the interface contact layer CA_S2 of the second standard cell 520 may directly connected in the second direction Y. Referring to FIG. 5, the cell boundaries CB_Y1 and CB_Y3 of the first standard cell 510 extend in the second direction Y, and the cell boundaries CB_Y2 and CB_Y4 of the second standard cell 520 extend in the second direction Y. Positions (e.g., coordinates) of the cell boundaries CB_Y1 and CB_Y3 of the first standard cell 510 in the first direction X and positions (e.g., coordinates) of the cell boundaries CB_Y2 and CB_Y4 of the second standard cell 520 in the first direction X may be the same as or different from each other.

The standard cells 510 and 520 may include an active region RX, a gate line GL, and a contact layer CA. An internal structure of the standard cells 510 and 520 may be the same as or similar in some respects to the structure of the standard cell 300 of FIG. 3, so a detailed description of the internal structure of the standard cells 510 and 520 is omitted herein for the sake of brevity.

In some example embodiments, the standard cells 510 and 520 may each include power contact layers CA_P1 and CA_P2 extending in the second direction Y. The power contact layers CA_P1 and CA_P2 may be connected to the first metal layer M1 through the via V0, and the standard cells 510 and 520 may be supplied with the power voltage VDD and the ground voltage VSS through the power contact layers CA_P1 and CA_P2. Referring to FIG. 6 together with FIG. 5, the power contact layers CA_P1 and CA_P2 may correspond to terminals NP1 and NP2 of P-type transistors TR1 and TR3 connected to the power voltage VDD and terminals NS1 and NS2 of N-type transistors TR2 and TR4 connected to the ground voltage VSS.

In some example embodiments, the standard cells 510 and 520 may each include interface contact layers CA_S1 and CA_S2 extending in the second direction Y. The interface contact layers CA_S1 and CA_S2 may extend to the cell boundary CB of each of the standard cells 510 and 520 extending in the first direction X. Referring to FIG. 6, the node ND1 of the first transistor 610 and the node ND2 of the second transistor 620 may be connected to each other. The node ND1 of the first transistor 610 may correspond to an output pin of the first standard cell 510, and the node ND2 of the second transistor 620 may correspond to an output pin of the second standard cell 520. The interface contact layers CA_S1 and CA_S2 may correspond to the node ND1 of the first transistor 610 and the node ND2 of the second transistor 620, respectively, and the nodes ND1 and ND2 may be referred to as interface nodes. The first standard cell 510 and the second standard cell 520 may be adjacently placed in the second direction Y, and the interface contact layer CA_S1 of the first standard cell 510 and the interface contact layer CA_S2 of the second standard cell 520 may be connected in the second direction Y (530). In some example embodiments, the interface contact layer CA_S1 of the first standard cell 510 may be further connected to another standard cell through via a 511 and a first metal layer 513.

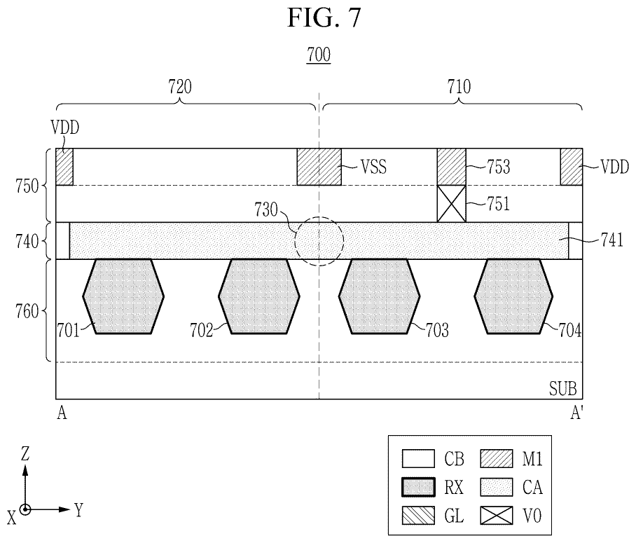

FIG. 7 illustrates a cross-sectional view along a line A-A′ of FIG. 5.

Referring to FIG. 7, an integrated circuit 700 may include a first standard cell 710 and a second standard cell 720. Herein, the first standard cell 710 may correspond to the first standard cell 510 of FIG. 5, and the second standard cell 720 may correspond to the second standard cell 520 of FIG. 5. The first standard cell 710 and the second standard cell 720 may be referred to as the first cell region 710 and the second cell region 720, respectively.

In some example embodiments, the integrated circuit 700 may include an active region 760 positioned on a substrate SUB and a source/drain region S/D formed in the active region 760. The first standard cell 710 may include a first source/drain region 703 and a second source/drain region 704 positioned in the active region 760 on the substrate SUB and spaced apart in the first direction X, and the second standard cell 720 may include a third source/drain region 701 and a fourth source/drain region 702 positioned in the active region 760 on the substrate SUB and spaced apart in the first direction X. The integrated circuit 700 may include insulating layers 740 and 750 placed on the active region 760.

In some example embodiments, the integrated circuit 700 may include a contact layer (CA) 741 positioned on the insulating layer 740. The contact layer 741 may electrically contact the source/drain region S/D on the source/drain region S/D, and may transmit logic signals of the first standard cell 710 and the second standard cell 720. The contact layer 741 may contact the source drain region S/D of the first standard cell 710 and the source/drain region S/D of the second standard cell 720. The contact layer 741 may extend in the second direction Y across the first standard cell 710 and the second standard cell 720 (730). Furthermore, the contact layer 741 may be further connected to another standard cell through a via 751 and a first metal layer 753. The integrated circuit 700 may further include first metal layers M1 placed on an insulating layer 750 and extending in the first direction X and supplying the power voltage VDD or the ground voltage VSS.

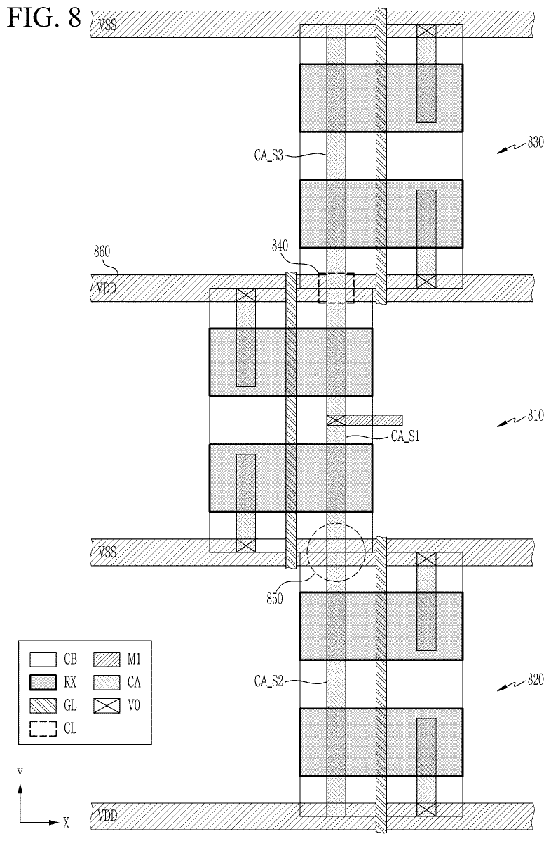

The integrated circuit design tool may place standard cells by considering an interconnection relationship between the standard cells, but a space within an integrated circuit may be limited, and non-interconnected standard cells may be placed adjacent to each other in the second direction Y. This may cause interface contact layers of non-interconnected standard cells to be electrically directly connected. This will be described with reference to FIG. 8.

FIG. 8 illustrates a layout view of standard cells 810, 820, and 830, according to some example embodiments.

Referring to FIG. 8, standard cells 810, 820, and 830 may be placed across first metal layers M1 between first metal layers M1 extending in the first direction X and placed parallel to each other in the second direction Y. Meanwhile, the first standard cell 810 may correspond to the first standard cell 510 of FIG. 5, and the second standard cell 820 may correspond to the second standard cell 520 of FIG. 5. Accordingly, the integrated circuit design tool may place the first standard cell 810 and the second standard cell 820 adjacent each other in the second direction Y based on the connection relationship of the standard cells, and interface contact layer CA_S1 of the first standard cell 810 and the interface contact layer CA_S2 of the second standard cell 820 may be directly connected in the second direction Y (850).

In some example embodiments, the third standard cell 830 may be placed adjacent to the first standard cell 810 in the second direction Y. However, the third standard cell 830 may not be interconnected with the first standard cell 810. The third standard cell 830 may not directly transmit/receive signals to/from the first standard cell 810. For example, the third standard cell 830 may transmit and receive signals to and from the first standard cell 810 through another standard cell (not shown), or the signals transmitted and received by the third standard cell 830 and the signals transmitted and received by the first standard cell 810 may be unrelated signals. In other words, the third standard cell 830 and the first standard cell 810 may be electrically insulated.

In some example embodiments, the integrated circuit design tool may place a cutting layer (CL) 840 between an interface contact layer CA_S3 of the third standard cell 830 and an interface contact layer CA_S1 of the first standard cell 810 to electrically insulate the third standard cell 830 and the first standard cell 810. The integrated circuit design tool may place the cutting layer 840 on the cell boundary CB extending in the first direction X of the third standard cell 830 and the first standard cell (810) by considering the connection relationship and placement of the third standard cell 830 and the first standard cell 810. The cutting layer 840 may overlap a portion of the first metal layer 860 extending in the first direction X at a boundary between the first standard cell 810 and the third standard cell 830. The cutting layer 840 may electrically insulate the third standard cell 830 and the first standard cell 810 by separating the interface contact layer CA_S3 of the third standard cell 830 and the interface contact layer CA_S1 of the first standard cell 810.

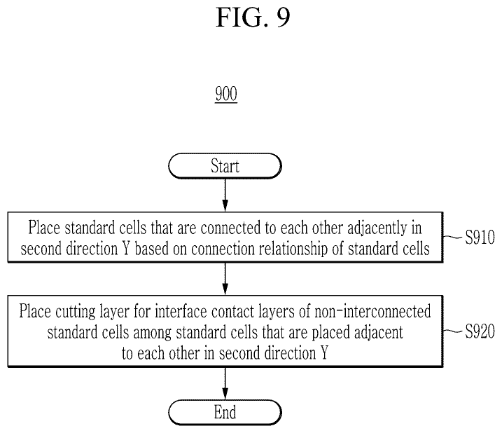

FIG. 9 illustrates a flowchart showing a standard cell positioning method of an integrated circuit design tool, according to some example embodiments.

According to a flowchart 900 of FIG. 9, in some example embodiments, when placing standard cells, the integrated circuit design tool may consider a connection relationship of the standard cells, and may place the standard cells that are connected to each other adjacent each other in the second direction Y based on the connection relationship of the standard cells (S910). The integrated circuit design tool may obtain the connection relationship between standard cells based on the netlist 150 (FIG. 1). For example, an integrated circuit design tool may determine, based on the netlist 150, that the first standard cell and the second standard cell are standard cells that are interconnected. Alternatively or in addition, the integrated circuit design tool may determine, based on the netlist 150, that the output pin of the first standard cell and the output pin of the second standard cell are directly connected, and thus the interface contact layer of the first standard cell corresponding to the output pin of the first standard cell and the interface contact layer of the second standard cell corresponding to the output pin of the second standard cell should be electrically connected. The integrated circuit design tool may place the first standard cell and the second standard cell adjacent to each other in the second direction Y such that the interface contact layer of the first standard cell and the interface contact layer of the second standard cell are directly connected.

In some example embodiments, some (e.g., two or more) of the standard cells placed adjacent each other in the second direction Y may be standard cells that are not interconnected. One or more of the standard cells among the standard cells placed adjacent each other in the second direction Y may not directly transmit and receive signals to and from each other. For example, among the standard cells placed adjacent each other in the second direction Y, the third standard cell and the fourth standard cell may transmit and receive signals to and from each other via the fifth standard cell, or the first signal transmitted and received by the third standard cell and the second signal transmitted and received by the fourth standard cell may be unrelated signals.

In some example embodiments, the integrated circuit design tool may place a cutting layer for interface contact layers of non-interconnected standard cells among standard cells that are placed adjacent to each other in the second direction Y (S920). The integrated circuit design tool may place a cutting layer to separate (isolate or insulate) interface contact layers of unrelated standard cells among standard cells that are placed adjacent to each other in the second direction Y. The integrated circuit design tool may place a cutting layer on a boundary of standard cells in the first direction X to electrically insulate the unrelated standard cells among the standard cells that are placed adjacent to each other in the second direction Y.

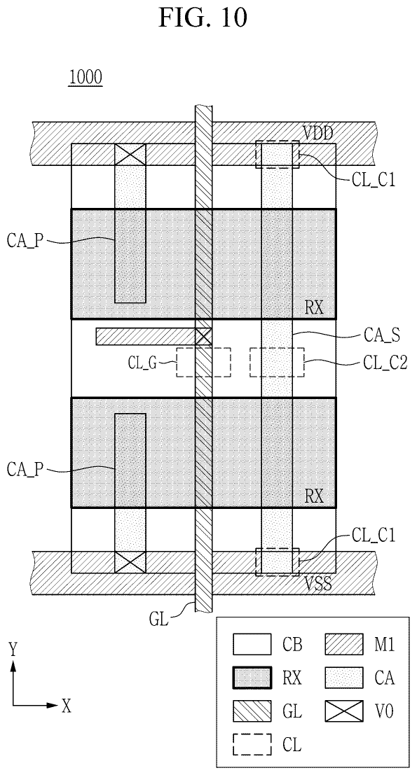

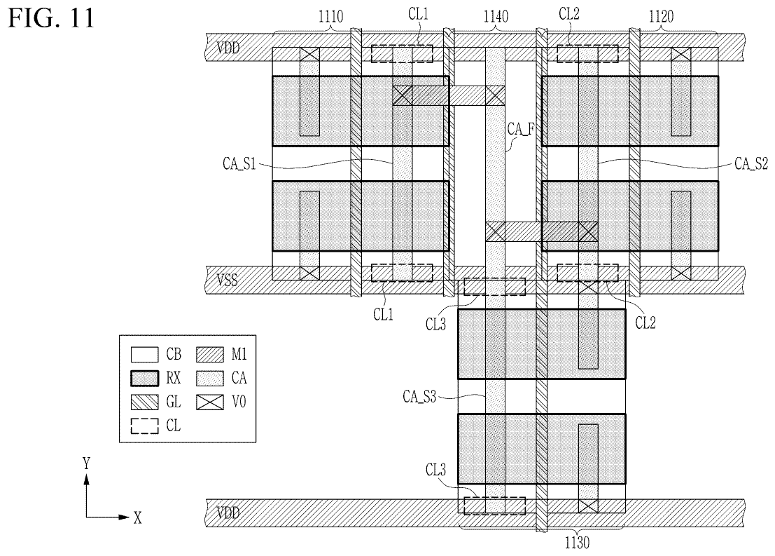

FIG. 10 illustrates a layout view of a standard cell stored in a cell library according to a comparative example, and FIG. 11 illustrates a layout view for describing a standard cell layout method of an integrated circuit design tool, according to a comparative example.

Referring to FIG. 10, a cell library according to a comparative example may store a standard cell 1000. The standard cell 1000 may include an active region RX, a gate line GL, a contact layer CA, and may be connected to the first metal layer M1 through the via V0. The contact layer CA may include a power contact layer CA_P connected to the first metal layer (M1) and supplied with the power voltage VDD or the ground voltage VSS, and an interface contact layer CA_S connected to another standard cell for transmitting and receiving a signal.

According to the comparative example, the standard cell 1000 may include a cutting layer for a conductive layer (e.g., contact layer and/or gate line). For example, the standard cell 1000 may include a cutting layer CL_C1 for electrically insulating the standard cells by cutting the interface contact layer CA_S between adjacent standard cells, and/or a cutting layer CL_C2 for cutting the interface contact layer CA_S within the standard cell 1000.

Furthermore, the standard cell 1000 may further include a cutting layer CL_G for cutting the gate line GL within the standard cell 1000. However, example embodiments are not limited thereto and in some example embodiments, the power contact layer CA_P may extend in the second direction Y, and the standard cell 1000 may further include a cutting layer for cutting the power contact layer CA_P.

Referring to FIG. 11, standard cells 1110, 1120, and 1130 may be placed across first metal layers M1 between the first metal layers M1 extending in the first direction X and placed parallel to each other in the second direction Y. Herein, the first standard cell 1110 and the second standard cell 1120 may be interconnected, and the third standard cell 1130 may be a standard cell that is not interconnected with the first standard cell 1110 and the second standard cell 1120.

According to the comparative example, standard cells stored in the cell library may include cut layers for interface contact layers. Referring to FIG. 11, the standard cells 1110, 1120, and 1130 stored in the cell library according to the comparative example may include a cutting layer CL_G for cutting a gate line, and may include cutting layers CL1, CL2, and CL3 for interface contact layers CA_S1, CA_S2, and CA_S3 among the contact layers. Accordingly, the standard cells that are placed adjacently in the second direction Y may be electrically insulated even though they are interconnected.

According to the comparative example, the integrated circuit design tool may consider the connection relationship of the standard cells when placing the standard cells. For example, as shown in FIG. 11, the integrated circuit design tool may place the first standard cell 1110 and the second standard cell 1120 adjacent to each other in the first direction X based on the connection relationship of the standard cells. However, example embodiments are not limited thereto. Meanwhile, according to the comparative example, the integrated circuit design tool may perform routing for the interface contact layer CA_S1 of the first standard cell 1110 and the interface contact layer CA_S2 of the second standard cell 1120 to electrically connect the interface contact layer CA_S1 of the first standard cell 1110 and the interface contact layer CA_S2 of the second standard cell 1120 based on the connection relationship between the first standard cell 1110 and the second standard cell 1120.

According to the comparative example, the integrated circuit design tool may place a filler cell 1140 between the first standard cell 1110 and the second standard cell 1120 to secure or otherwise provide a routing space for the interface contact layer CA_S1 of the first standard cell 1110 and the interface contact layer CA_S2 of the second standard cell 1120. The filler cell 1140 may be a cell that may not perform any logical operation, and may be used to maintain well continuity between adjacent standard cells. The interface contact layer CA_S1 of the first standard cell 1110 and the interface contact layer CA_S2 of the second standard cell 1120 may be electrically connected through the contact layer CA_F, the via V0, and the first metal layer M1 in the filler cell 1140. However, example embodiments are not limited thereto, and the interface contact layer CA_S1 of the first standard cell 1110 and the interface contact layer CA_S2 of the second standard cell 1120 may be electrically connected through upper metal layers.

A size of the filler cell 1140 may vary. In some example embodiments, the size of the filler cell 1140 in the first direction X may vary, so filler cells of various sizes may be placed in the first direction X between the first standard cell 1110 and the second standard cell 1120 to satisfy or otherwise comply with various design rules, such as a routing length of metal layers or a predetermined minimum distance between the metal layers. In order to satisfy or comply with various design rules, an additional space may be provided for filler cells and routing.

Standard cells stored in the cell library according to some example embodiments may not include a cutting layer for the interface contact layer. In some example embodiments, the integrated circuit design tool may advantageously reduce the routing space for electrically connecting the standard cells by placing the standard cells in the second direction Y based on the connection relationship of the standard cells.

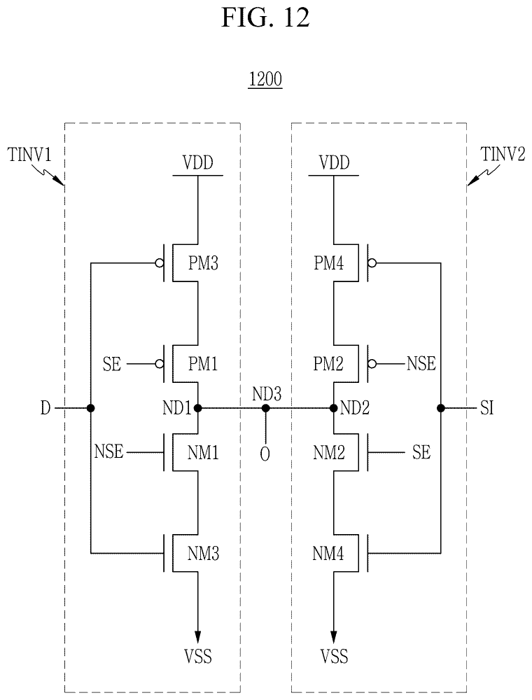

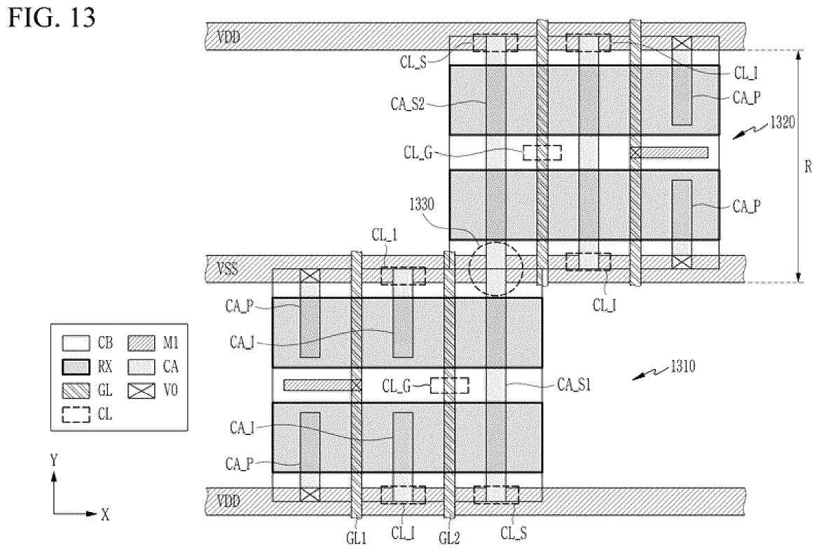

FIG. 12 illustrates a circuit diagram for describing a connection method of a standard cell according to some example embodiments, and FIG. 13 illustrates a layout diagram for describing a circuit according to FIG. 12 including a standard cell according to some example embodiments.

The circuit diagram of FIG. 12 may be a multiplexer 1200 that may receive a data signal D and a scan signal SI, selects one of the data signal D and the scan signal SI according to an operation mode, and outputs it as an output signal O. Herein, for the sake of brevity, descriptions of a specific operation method and a connection relationship of the transistors within the multiplexer 1200 will be omitted.

The multiplexer 1200 may include a first tri-state inverter TINV1 and a second tri-state inverter TINV2. The first tri-phase inverter TINV1 and the second tri-phase inverter TINV2 may share an output node (ND3) and may be placed to face each other. The multiplexer 1200 may be implemented as a single standard cell, or the first tri-phase inverter TINV1 and the second tri-phase inverter TINV2 may each be implemented as a standard cell to form a single multiplexer 1200. Herein, it is described assuming that the first tri-phase inverter TINV1 and the second tri-phase inverter TINV2 may each be implemented as standard cells to form one multiplexer 1200.

A scan enable signal SE may be applied to a gate terminal of a first transistor PM1 of a first three-phase inverter TINV1 and a gate terminal of a second transistor NM2 of a second three-phase inverter TINV2, and an inverted scan enable signal NSE may be applied to a gate terminal of a third transistor NM1 of the first tri-phase inverter TINV1 and a gate terminal of a fourth transistor PM2 of the second tri-phase inverter TINV2. The output node ND3 of the first tri-phase inverter TINV1 and the second three-phase inverter TINV2 may be interface nodes, and according to the circuit diagram of FIG. 12, the output node ND1 of the first three-phase inverter TINV1 and the output node ND2 of the second three-phase inverter TINV2 may be directly connected to each other.

Referring to FIG. 13, a first standard cell 1310 may correspond to the first tri-phase inverter TINV1 of FIG. 12, and a second standard cell 1320 may correspond to the second tri-phase inverter TINV2 of FIG. 12. The first standard cell 1310 may include a first gate line GL1 that receives a data signal D and a second gate line GL2 that receives a scan enable signal SE and an inverted scan enable signal NSE. Meanwhile, the second gate line GL2 may be electrically isolated within the first standard cell 1310 by a cutting layer CL_G for the gate line.

The first standard cell 1310 may include a power contact layer CA_P supplied with the power voltage (VDD) or the ground voltage VSS, and may include internal contact layers CA_I electrically connecting internal transistors of the first standard cell 1310 (e.g., transistors PM3 and PM1 of TINV1 in FIG. 12, or transistors NM1 and NM3). The first standard cell 1310 may include cutting layers CL_I for inner contact layers CA_I.

In some example embodiments, the first standard cell 1310 may include an interface contact layer CA_S1. Referring to FIG. 12, the interface contact layer CA_S1 may correspond to the output node ND1 of the first tri-phase inverter TINV1. The interface contact layer CA_S1 may extend in the second direction Y, and may extend to the cell boundary CB of the first standard cell 1310 in the first direction X. The standard cell 1310 according to some example embodiments may not include a cutting layer for the interface contact CA_S1. The second standard cell 1320 may include an interface contact layer CA_S2 corresponding to the output node ND2 of the second tri-phase inverter TINV2. An internal structure of the second standard cell 1320 may be identical to or similar in some respects to that of the first standard cell 1310, and a detailed description of the internal structure of the second standard cell 1320 will be omitted herein for the sake of brevity of explanation.

In some example embodiments, the integrated circuit design tool may place the first standard cell 1310 and the second standard cell 1320 adjacent to each other in the second direction Y based on the connection relationship of the standard cells. According to some example embodiments, the interface contact layer CA_S1 of the first standard cell 1310 and the interface contact layer CA_S2 of the second standard cell 1320 may be directly connected (e.g., at 1330) in the second direction Y based on a connection relationship between the first standard cell 1310 and the second standard cell 1320. The integrated circuit design tool may add a cutting layer CL_S to the interface contact layer CA_S1 of the first standard cell 1310 or the interface contact layer CA_S2 of the second standard cell 1320 based on the connection relationship between the standard cells and the placement of the standard cells.

In the present disclosure, a height of the standard cells is illustrated as being equal to a distance between the first metal layers extending in the first direction X and adjacent in the second direction Y, but the standard cells may be placed across three or more first metal layers. For example, if the distance between first metal layers extending in the first direction X and adjacent in the second direction Y is defined as R, in some example embodiments, standard cells may have a height corresponding to nR (n is a natural number greater than or equal to 2).

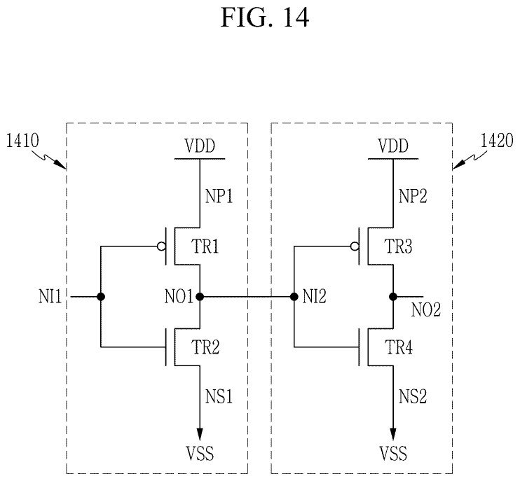

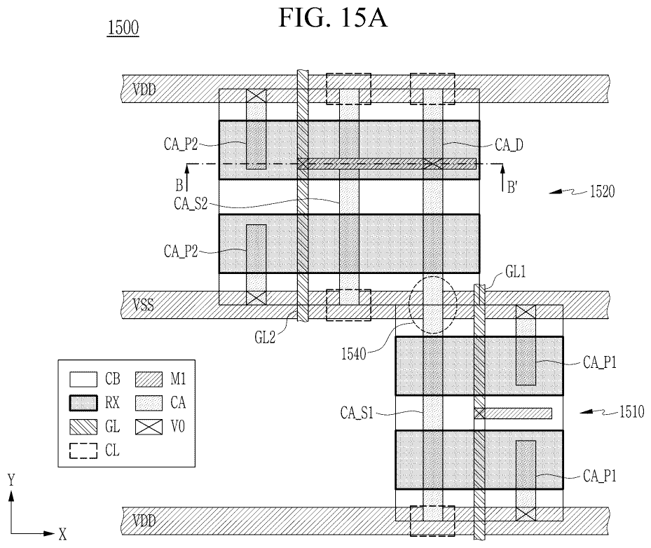

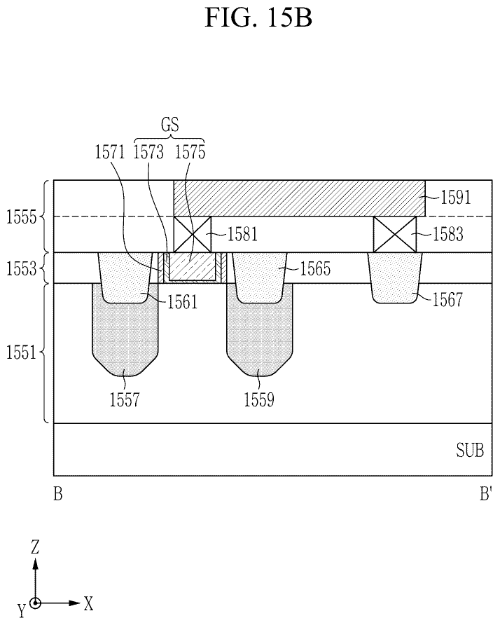

FIG. 14 illustrates a circuit diagram for describing connections of a standard cell according to some example embodiments, FIG. 15A illustrates a layout view of a circuit according to FIG. 14 including a standard cell according to some example embodiments, and FIG. 15B illustrates a cross-sectional view of a line B-B′ of FIG. 15A.

Referring to FIG. 14, transistors 1410 and 1420 may transmit and receive logic signals between each other. As illustrated, the transistors 1410 and 1420 may be connected in a cascade configuration and an output signal of the first transistor 1410 may be transmitted as an input signal of the second transistor 1420. An output node NO1 of the first transistor 1410 may be connected to an input node NI2 of the second transistor 1420. Herein, for the sake of brevity of discussion, a description of a specific connection relationship between the transistors 1410 and 1420 will be omitted.

Referring also to FIG. 15A, an integrated circuit 1500 may include a first standard cell 1510 and a second standard cell 1520. The first standard cell 1510 may correspond to the first transistor 1410 (FIG. 14), and the second standard cell 1520 may correspond to the second transistor 1420 (FIG. 14). The first standard cell 1510 may include a gate line GL1 that may receive an external signal and corresponds to an input node NI1 of the first transistor 1410, a power contact layer CA_P1 that corresponds to nodes NP1 and NS1 of the first transistor 1410 and is supplied with the power voltage VDD or the ground voltage VSS, and an interface contact layer CA_S1 that corresponds to an output node NO1 of the first transistor 1410. The second standard cell 1520 may include a gate line GL2 corresponding to an input node NI2 of the second transistor 1420, a power contact layer CA_P2 corresponding to nodes NP2 and NS2 of the second transistor 1420 and supplied with the power voltage VDD or the ground voltage VSS, and an interface contact layer CA_S2 corresponding to an output node NO2 of the second transistor 1420. The second standard cell 1520 according to some example embodiments may further include a dummy contact layer CA_D. The dummy contact layer CA_D may be a layer that may not correspond to any of the input pins and output pins of the standard cell.

In some example embodiments, an integrated circuit design tool may electrically connect the interface contact layer CA_S1 of the first standard cell 1510 and the gate line GL2 of the second standard cell 1520 using the dummy contact layer CA_D. The integrated circuit design tool may place the first standard cell 1510 and the second standard cell 1520 adjacent to each other in the second direction Y based on the connection relationship between the first standard cell 1510 and the second standard cell 1520, and may connect the gate line GL2 of the second standard cell 1520 to the dummy contact layer CA_D. According to some example embodiments, depending on the connection relationship between the first standard cell 1510 and the second standard cell 1520, the gate line GL2 of the second standard cell 1520 may be connected to the dummy contact layer CA_D, and the interface contact layer CA_S1 of the first standard cell 1510 and the dummy contact layer CA_D of the second standard cell 1520 may be directly connected in the second direction Y (1540). Meanwhile, based on the connection relationship between standard cells and the placement of standard cells, the integrated circuit design tool may add a cutting layer CL for the contact layers CA_S1, CA_S2, and CA_D.

Referring to FIG. 15B, source/drain regions 1557 and 1559 may be formed in the active region 1551 on the substrate SUB. The source/drain regions 1557 and 1559 may be spaced apart in the first direction X. Insulating layers 1553 and 1555 may be positioned on the active region 1551. The cross-sectional view of the integrated circuit 1500 in FIG. 15B may be same as or similar in some respects to the cross-sectional view of the integrated circuit 700 in FIG. 7, and therefore may be best understood with reference thereto.

In some example embodiments, the insulating layer 1553 on the active region 1551 may include a gate structure GS and contact layers 1561, 1565, and 1567. The gate structure GS may extend in the second direction Y. The gate structure GS may include a gate electrode 1575 and a gate insulation layer 1573. The gate insulating layer 1573 may extend along a side surface of the gate spacer 1571. The gate structure GS may be positioned between the source and drain regions 1557 and 1558. In some example embodiments, the gate structure GS may correspond to the input node NI2 of the second transistor 1420 (FIG. 14). The source and drain regions 1557 and 1559 and the gate structure GS may form a transistor.

In some example embodiments, the contact layer 1561 may correspond to the power contact layer CA_P2 of the second standard cell 1520 (FIG. 15A), and the contact layer 1565 may correspond to the interface contact layer CA_S2 of the second standard cell 1520. The contact layer 1561 may correspond to the node NP2 of the second transistor 1420 (FIG. 14), and the contact layer 1565 may correspond to the output node NO2 of the second transistor 1420. The contact layers 1561 and 1565 may contact the source and drain regions 1557 and 1559.

According to some example embodiments, the contact layer 1567 may correspond to the dummy contact layer CA_D of the second standard cell 1520. The contact layer 1567 may be a layer that may not contact the source and drain regions. The contact layer 1567 may be a layer that may not correspond to any node of the second transistor 1420.

In some example embodiments, the gate structure GS and the contact layer 1567 may be electrically connected through vias 1581 and 1583 formed in an insulating layer 1555 and a metal layer 1591. The integrated circuit design tool may electrically connect the gate structure GS and the contact layer 1567 using the vias 1581 and 1583 formed in the insulating layer 1555 and the metal layer 1591.

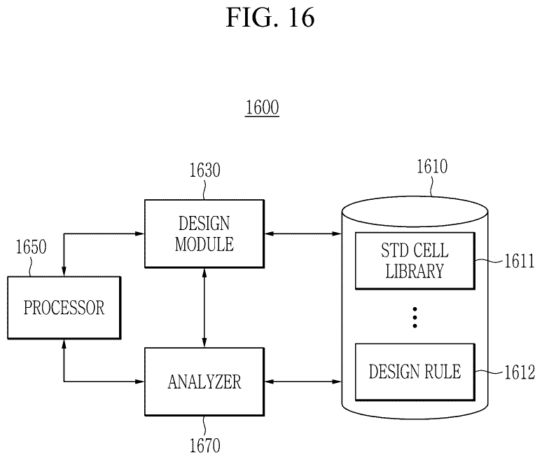

FIG. 16 illustrates a schematic diagram showing a design system 1600 for designing an integrated circuit, according to some example embodiments.

The design system 1600 may include a storage device 1610, a design module 1630, a processor 1650, and an analysis module 1670. The design system 1600 of FIG. 16 may perform at least some of the design operations of the integrated circuit described in the design methods of the integrated circuit of FIGS. 1 to 9 and FIGS. 12 to 15B. The design system 1600 may be implemented as an integrated device, and may thus be referred to as a design device. The design system 1600 may be provided as a dedicated or special-purpose device for designing integrated circuits. In some example embodiments, the design system 1600 may be a computer that executes computer-readable instructions (e.g., program code) for executing various simulation tools or design tools using a standard cell library 1611 and design rules 1612 stored in the storage device 1610 to implement the method of designing and manufacturing an integrated circuit of FIG. 1 and perform other tasks disclosed herein.

The storage device 1610 according to some example embodiments may store the standard cell library 1611 and the design rules 1612. The storage device 1610 comprises one or more disks, tape drives, or solid-state drives, and may be used as an over-flow data storage device, to store programs when such programs are selected for execution, and to store instructions and data that are read during program execution. The storage device 1610 may be volatile or non-volatile and may comprise a read-only memory (ROM), random-access memory (RAM), ternary content-addressable memory (TCAM), dynamic random-access memory (DRAM), and static random-access memory (SRAM). In some example embodiments, the standard cell library 1611 may include layout information for standard cells. For example, the standard cell library 1611 may include layout information such as an active region forming a standard cell, a contact layer contacting the active region, and/or a gate line. The standard cell library 1611 according to some example embodiments may not include a cutting layer for a contact layer forming a standard cell. The contact layers forming the standard cell may not include a cutting layer for an interface contact layer that is connected to another standard cell. Accordingly, the interface contact layers of standard cells that are placed adjacently in a specific direction may be integrally connected. The standard cell library 1611 and the design rules 1612 within the storage device 1610 may be provided from the storage device 1610 to the design module 1630 and/or the analysis module 1670. A number of cell libraries included in the storage device 1610 may vary.

The design module 1630 according to some example embodiments may receive the standard cell library 1611 and the design rules 1612 from the storage device 1610 to perform design operations of the integrated circuits of FIGS. 1 to 9 and FIGS. 12 to 15B. In some example embodiments, the design module 1630 may perform a routing operation on standard cells after performing a placement operation on the standard cells using the standard cell library 1611. Herein, the term “module” may refer to software, hardware such as a field programmable gate array (FPGA) or an application specific integrated circuit (ASIC), or a combination of software and hardware.

The processor 1650 may be used by the design module 1630 and the analysis module 1670 to perform calculations. For example, the processor 1650 may include a microprocessor, an application processor (AP), a digital signal processor (DSP), a graphic processing unit (GPU), etc. Although only one processor 1650 is illustrated in FIG. 16, the design system 1600 may include multiple processors according to some example embodiments. The processor 1650 may also include a cache memory to improve, maximize or optimize computational capabilities.

The analysis module 1670 may perform analysis and/or verification on the layout generated by the design module 1630 during and/or after performing the design operations of the integrated circuits of FIGS. 1 to 9 and FIGS. 12 to 15B. In some example embodiments, the analysis module 1670 may analyze and/or verify whether the standard cells and metal layers satisfy the design rules 1612 received from the storage device 1610 based on the design rules 1612.

As described herein, any devices, systems, modules, portions, units, controllers, circuits, and/or portions thereof according to any of the example embodiments, and/or any portions thereof (including, without limitation, the storage device 1610, the design module 1630, the processor 1650, the analysis module 1670, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A layout design method for an integrated circuit, comprising:
obtaining a connection relationship of a plurality of standard cells;
placing a first standard cell of the plurality of standard cells and a second standard cell of the plurality of standard cells adjacent to each other in a first direction based on the connection relationship between the first standard cell and the second standard cell; and
placing a cutting layer for a contact layer between the first standard cell and a third standard cell of the plurality of standard cells based on the connection relationship between the first standard cell and the third standard cell, wherein the third standard cell is arranged adjacent to the first standard cell in the first direction.

2. The layout design method of claim 1, wherein the obtaining the connection relationship of the plurality of standard cells includes:
receiving a netlist; and
determining that the first standard cell and the second standard cell are interconnected based on the netlist.

3. The layout design method of claim 2, wherein the determining that the first standard cell and the second standard cell are interconnected includes:
determining that an output pin of the first standard cell and an output pin of the second standard cell are directly connected.

4. The layout design method of claim 1, wherein the placing of the first standard cell of the plurality of standard cells and the second standard cell of the plurality of standard cells adjacent to each other in the first direction includes:
placing the first standard cell and the second standard cell such that the first standard cell and the second standard cell overlap a portion of a first line extending in a second direction perpendicular to the first direction between the first standard cell and the second standard cell, and a contact layer of the first standard cell and a contact layer of the second standard cell are directly connected in the first direction.

5. The layout design method of claim 4, further comprising: supplying, using the first line, a power voltage or a ground voltage to the first standard cell and the second standard cell.

6. The layout design method of claim 1, wherein the placing the cutting layer for the contact layer between the first standard cell and the third standard cell based on the connection relationship includes:
determining that the first standard cell and the third standard cell are not interconnected based on the connection relationship of the plurality of standard cells; and
placing the cutting layer separating a contact layer of the first standard cell and a contact layer of the third standard cell.

7. The layout design method of claim 6, wherein placing the cutting layer includes:
positioning the cutting layer at a boundary between the first standard cell and the third standard cell and overlapping a portion of a second line extending in a second direction perpendicular to the first direction.

8. An integrated circuit comprising:
a first line configured to extend in a first direction;
a first standard cell configured to have a size defined by a plurality of first cell boundaries extending in the first direction and along a second direction perpendicular to the first direction and a plurality of second cell boundaries extending in the second direction and along the first direction, wherein the first standard cell includes a first active region and a first contact layer extending in the second direction and contacting the first active region, and wherein at least one of the first cell boundaries overlaps the first line; and
a second standard cell configured to have a size defined by a plurality of third cell boundaries extending in the first direction and along the second direction and a plurality of fourth cell boundaries extending in the second direction and along the first direction, wherein the second standard cell includes a second active region and a second contact layer extending in the second direction and directly connected to the first contact layer and contacting the second active region, and wherein at least one of the third cell boundaries overlaps the first line.

9. The integrated circuit of claim 8, wherein the integrated circuit further includes:
a second line configured to extend in the first direction and spaced apart from the first line in the second direction; and
a third line configured to extend in the first direction, wherein a distance between the first line and the second line and a distance between the first line and the third line are same,
wherein one of the plurality of first cell boundaries overlaps the second line, and
one of the plurality of third cell boundaries overlaps the third line.

10. The integrated circuit of claim 9, wherein
the first contact layer extends in the second direction from a cell boundary overlapping the first line to a cell boundary overlapping the second line, the cell boundary overlapping the first line and the cell boundary overlapping the second line being among the plurality of first cell boundaries, and
the second contact layer extends in the second direction from the cell boundary overlapping the second line to a cell boundary overlapping the third line, the cell boundary overlapping the second line and the cell boundary overlapping the third line being among the plurality of third cell boundaries.

11. The integrated circuit of claim 8, further comprising:
a second line extending in the first direction, be spaced apart from the first line in the second direction, and overlap one of the plurality of first cell boundaries;
a third standard cell configured to include a third contact layer extending in the second direction and contacting a third active region, and a cell boundary overlapping the second line and extending in the first direction; and
a cutting layer configured to separate the first contact layer and the third contact layer.

12. The integrated circuit of claim 11, wherein
the cutting layer overlaps a portion of the second line at a boundary between the first standard cell and the third standard cell.

13. The integrated circuit of claim 8, wherein
the first standard cell further includes a gate line extending in the second direction and electrically connected to the first contact layer.

14. The integrated circuit of claim 13, wherein the first contact layer is a dummy contact layer.

15. A semiconductor device comprising:
a substrate configured to include a first cell region and a second cell region adjacent to the first cell region in a first direction;
a first source region and a first drain region on the substrate and spaced apart in the first direction from each other within the first cell region;
a second source region and a second drain region on the substrate and spaced apart in the first direction from each other within the second cell region; and
a first contact layer extending in the first direction and on the first source region, the first drain region, the second source region, and the second drain region, and contacting the first source region, the first drain region, the second source region, and the second drain region.

16. The semiconductor device of claim 15, wherein
the substrate further includes a third cell region adjacent to the first cell region in the first direction, and
the semiconductor device further includes:
a third source region and a third drain region on the substrate and spaced apart in the first direction from each other within the third cell region;
a second contact layer on the third source region and the third drain region, and configured to contact the third source region and the third drain region, and extend in the first direction; and
a cutting layer configured to separate the first contact layer and the second contact layer.

17. The semiconductor device of claim 16, wherein
the first contact layer, the second contact layer, and the cutting layer are in a same layer.

18. The semiconductor device of claim 15, wherein
the first contact layer is connected to upper metal layers on the first contact layer through a first via.

19. The semiconductor device of claim 15, further comprising
a first metal layer configured to extend in a second direction perpendicular to the first direction at a boundary between the first cell region and the second cell region.

20. The semiconductor device of claim 19, wherein
the first cell region further includes a power contact layer connected to the first metal layer through a via and configured to contact one of the first source region and the first drain region.
